(19) United States
(12) Patent Application Publication
(10) Pub. No.: US 2025/0383872 A1
(43) Pub. Date: Dec. 18, 2025

(54) MACHINE NEUTRAL CONTAINERIZED APPLICATIONS

(71) Applicant: Oracle International Corporation, Redwood Shores, CA (US)

(72) Inventors: Bryan Phillippe, Auburn, WA (US); Ryan Ruppert, Alamo, NV (US)

(73) Assignee: Oracle International Corporation, Redwood Shores, CA (US)

(21) Appl. No.: 18/744,509

(22) Filed: Jun. 14, 2024

(51) Int. Cl. G06F 9/30

(52) U.S. Cl. CPC G06F 9/30145

(57) ABSTRACT

The system and methods for creating, managing, and transmuting containerized applications to build machine-neutral applications that can run on different machines with different processor architectures. The present disclosure receives an input container comprising of a machine-neutral application layer, a metadata layer or one or more machine-dependent layers. An instruction set architecture (ISA) is determined and one or more modified input containers are generated based on the identified ISA. One or more machine-dependent layers are dynamically built and inserted in one or more modified input containers. The present disclosure creates a dynamic-composition metadata layer in modified input containers, wherein the dynamic-composition metadata includes execution instructions, environment variables, or machine specific attributes. The present disclosure selects and inserts the matching machine-dependent layer of one or more machine-dependent layers using dynamic-composition metadata in the modified input containers. One or more modified input containers that are ISA-agnostic are returned as output result.

### BACKGROUND

Containers enable implementing operating-system level virtualization. They are self-contained execution environments that can have their own dedicated CPU, memory, input/output (I/O) interfaces, network resources, but may share a kernel of a host operating system. In traditional containerized applications, a container may be fully composed at build time of a set of one or more layers that can provide data such as applications, files, and objects; and metadata such as execution instructions, environment variables, and attributes. A fully composed and “runnable” container can then be run on container execution frameworks or within a container runtime environment. The composed container can comprise an executable application that runs on the virtual (or physical) machine in the operating environment of a host. This application either has to be compiled into an executable application (such that it adheres to the instruction set architecture of the processor (or processors) of the host operating environment) or the host operating environment may need to provide an emulation layer (such as QEMU) that enables running the application. Some examples of common machine architectures are x86_64 or amd64 (Intel 64-bit instruction set), and arm64 or aarch64 (64-bit ARM instruction set).

Software translators, also referred to as software emulators, software simulators, dynamic binary translators and the like, can also be used to translate the binary of an executable application from the instruction set architecture of one processor to an instruction set architecture of a different processor. One disadvantage of this approach is that it might lead to a suboptimal binary code, as the translator tool might not be able to fully exploit the architecture of the target processor. Consequently, the degradation in performance may fail to be acceptable to a certain group of users, as their applications deliver quality of service only if their tasks meet soft or hard deadlines.

A few application environments may allow software developers to write an application in a high-level language and then execute it on any target processor without the need to recompile it. Some examples of these machine-neutral applications in the prior art are Java applications that are compiled to run on Java Virtual Machine (JVM), Python applications, and Bourne shell scripts. Java applications are compiled to an intermediate bytecode stand, which can run in a self-contained environment called the Java Runtime Environment (JRE). Python programs may be interpreted just-in-time or precompiled into a machine-neutral bytecode, which can be executed within a Python runtime environment. When machine-neutral applications are packaged into a runnable container, they can lose their portability advantage as they may have to be executed/interpreted/hosted by an executable application that can run on a particular machine supporting the instruction set architecture. Consequently, the entire container application can run on a given machine supporting the instruction set architecture. This prevents the possibility of building/deploying one “runnable” container application image that can run on different machines with different instruction sets. Therefore, developers of the container applications may have to either build multiple containers (one for each machine with a unique instruction set architecture) or use an expensive emulation that can degrade the performance of applications.

### SUMMARY

In some embodiments, a computer-implemented method is provided for creating, managing, and/or transmuting containerized applications to provide machine-neutral applications that can run on different machines with different processor architectures. An input container is accessed from a client device where the input container is a portable and independently packaged executable code. The input container may include a machine-neutral application layer, a metadata layer or one or more machine-dependent layers. In an aspect of the present disclosure, the machine-neutral application layer can include machine-neutral applications such as Java/JVM applications, Python applications, Bourne shell scripts, and others, which are designed to execute on different underlying machines. Java applications are compiled to an intermediate bytecode stand, which can run in a self-contained environment called the Java Runtime Environment (JRE). Python programs may be interpreted just-in-time or precompiled into a machine-neutral bytecode, which can be executed within a Python runtime environment. An instruction set architecture (ISA) information is determined from the input container of the underlying hardware architecture of a processor in a deployment environment by using an ISA discovery. The instruction set architecture includes binary representation of a software application that runs on the processor of a computing machine supporting the instruction set architecture. Some examples of instruction set architecture includes an Intel 64-bit instruction set architecture or a 64-bit ARM instruction set architecture. The ISA discovery service determines the processor type, one or more available computing resources, one or more associated instruction sets or one or more hardware configurations of the underlying hardware architecture of a deployment environment.

The present disclosure may further utilize one or more binary versions of an instruction set architecture, one or more compiler configurations associated with an input container, one or more runtime settings of the input container to create one or more modified input containers based on the identified instruction set architecture. One or more machine-dependent layers can be dynamically built and can be inserted in one or more modified input containers. The one or more machine-dependent layers are added in conjunction with one or more machine-neutral application layers of the input container. In an aspect of the present disclosure, one or more alternate machine-dependent layers for one or more modified input containers may be dynamically built for a plurality of instruction set architectures. The matching machine-dependent layer with the underlying instruction set architecture of a deployment environment is then dynamically selected. The matching machine-dependent layer can be inserted in one or more modified input containers at the time of deploying the application.

Dynamic-composition metadata can be created in one or more modified input containers based on identified underlying instruction set architecture of a deployment environment. The dynamic-composition metadata includes one or more execution instructions, one or more environment variables, or one or more machine specific attributes of the deployment environment. The dynamic-composition metadata can be inserted manually or programmatically in one or more modified input containers. Using the dynamic-composition metadata, the matching machine-dependent layer of one or more machine-dependent layers with the underlying instruction set architecture of the deployment environment can be selected. The matching machine-dependent layer of one or more machine-dependent layers are inserted in the one or more modified input containers. In an aspect of the present disclosure, one or more modified input containers can be received comprising of a machine-neutral application layer, one or more metadata layers, or one or more specified machine-dependent metadata layers of one type of instruction set architecture. A new output container is rebuilt by substituting one or more machine dependent metadata layers in the one or more modified input containers for one or more machine-dependent metadata layers of another type of instruction set architecture. One or more output containers are returned as an output result where the output containers are configured to dynamically discover and adapt to underlying ISA of the deployment environment.

In some embodiments, a computer-implemented method is provided that includes: receiving an input container from a client device wherein the input container is a portable and independently executable package of code; determining, from the input container, an instruction set architecture (ISA) information of an underlying hardware architecture of a deployment environment, wherein the instruction set architecture includes binary representation of a software that runs on a computing machine having one or more particular characteristics; generating one or more modified input containers based on an identified instruction set architecture by selecting one or more corresponding binary versions of instruction set architecture, one or more compiler configurations associated with the input container, or one or more runtime settings of the input container; dynamically building one or more machine-dependent layers in the one or more modified input containers; dynamically inserting the one or more machine-dependent layers are inserted in the one or more modified input containers, wherein the one or more machine-dependent layers are inserted in conjunction with one or more machine-neutral application layers of the input container; creating dynamic-composition metadata in the one or more modified input containers based on the identified instruction set architecture of a deployment environment, wherein the dynamic-composition metadata includes one or more execution instructions, one or more environment variables, or one or more machine specific attributes; selecting a matching machine-dependent layer of one or more machine-dependent layers with the instruction set architecture of the deployment environment using the dynamic-composition metadata created in the one or more modified input containers; inserting the matching machine-dependent layer of one or more machine-dependent layers in the one or more modified input containers; outputting the one or more modified input containers.

The one or more machine-dependent layers may be or may have been built agnostic to instruction set architecture. The input container may include a machine-neutral application layer, a metadata layer or one or more machine-dependent layers. The instruction set architecture may include an Intel 64-bit instruction set architecture or a 64-bit ARM instruction set architecture. Determining the instruction set architecture (ISA) information of the underlying hardware architecture of the deployment environment may include evaluating a processor type of an underlying hardware architecture of the deployment environment. Determining the instruction set architecture (ISA) information of the underlying hardware architecture of the deployment environment may include evaluating one or more available computing resources of an underlying hardware architecture of the deployment environment. Determining the instruction set architecture (ISA) information of the underlying hardware architecture of the deployment environment may include evaluating one or more associated instruction sets or one or more hardware configurations of an underlying hardware architecture of the deployment environment. A method disclosed herein may further include: building one or more alternate machine-dependent layers in the one or more modified input containers for plurality of instruction set architectures; dynamically selecting the matching machine-dependent layer with the instruction set architecture of the deployment environment; and inserting the matching machine-dependent layer in the one or more modified input containers at deployment. A method disclosed herein may further include: receiving one or more modified input containers comprising of a machine-neutral application layer, one or more metadata layers, or one or more specified machine-dependent metadata layers of one architecture; rebuilding a new output container by substituting one or more machine dependent metadata layers in the one or more modified input containers for different one or more machine-dependent metadata layers of another architecture; outputting the new output container wherein the new output container is configured to dynamically discover and adapt to underlying ISA of the deployment environment.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The present disclosure is described in conjunction with the appended figures:

FIG. 1 is an illustrative block diagram of a computer-implemented method that may be utilized for creating, managing, and transmuting containerized applications to build machine-neutral applications that can run on different machines with different processor architectures.

FIG. 2 is an example illustration of containerized application deployment model in accordance with some embodiments of the disclosure.

FIG. 3 illustrates the steps of generating fully composed containers with machine-dependent layers using dynamic composition process in accordance with some embodiments of the disclosure.

FIG. 4 illustrates the steps of generating fully composed containers with machine-dependent layers using a step-by-step process including receiving input containers, generating and embedding metadata and dynamic resolution.

FIG. 5 illustrates the block diagram of generating a machine architecture for a specific container runtime environment using ISA discovery service and adaption engine in accordance with some embodiments of the disclosure.

FIG. 6 illustrates a process of transmuting a container with machine-dependent metadata layers of an example instruction set architecture into fully composed container compatible with different instruction set architecture in accordance with some embodiments of the disclosure.

FIG. 7 illustrates an example flow of a method for obtaining the final output result of fully composed container configured to be a machine-neutral application that can run machines having processors with different architecture in accordance with some embodiments of the present disclosure.

FIG. 8 illustrates a simplified diagram of a distributed system for implementing the method of FIG. 1.

FIG. 9 illustrates a simplified block diagram of a cloud-based system environment in which various service of servers may be offered as cloud services.

FIG. 10 illustrates an example architecture of a computing system that can implement at least one example of the disclosed method.

FIG. 11 illustrates an exemplary server which may include a processor, a memory, and a mass storage device.

In the appended figures, similar components and/or features may have the same reference label. Further, various components of the same type may be distinguished by following the reference label with a dash and a second label that distinguishes among the similar components. If only the first reference label is used in the specification, the description applies to any one of the similar components having the same first reference label irrespective of the second reference label.

### DETAILED DESCRIPTION

The ensuing description provides preferred exemplary embodiment(s) only and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as outlined in the appended claims.

In some embodiments of the present disclosure, techniques are provided for creating, managing, and/or transmuting containerized applications to provide machine-neutral applications that can run on different machines with different processor architectures. An input container may be received from a client device, where the input container is a portable and independently packaged executable code. Container is a portable and independently executable package of code. Applications that compose of independent packages of codes are called containerized applications. Containers may also combine libraries, binaries, configuration files, frameworks, and other dependencies that an application may require to execute on any host operating system into a single lightweight executable.

Containers offer compatibility with multiple contexts, ranging from private data centers to public clouds or personal laptops, by virtualizing the operating system. This logical packaging decouples applications from their runtime environments, allowing for simple and consistent deployment regardless of the target execution environments. Containers also isolate software from its underlying infrastructure, encapsulating dependencies and isolating them within a secure environment. Applications are regularly deployed across several environments using popular engines such as docker, that simplifies cloud migration by taking advantage of automation features via APIs provided by container engines or orchestrators.

The input container includes a machine-neutral application layer, a metadata layer or one or more machine-dependent layers. The machine-neutral application layer can include machine-neutral applications such as Java/JVM applications, Python applications, Bourne shell scripts, and others, which are designed to be able to execute transparently on any underlying processor architecture. The metadata layer includes descriptions of container image such as container image name, tags, labels, execution instructions, environment variables, exposed ports, volumes, entry point and attributes. The metadata layer includes information about the container's usage instructions and other relevant details of the container. The data that can be utilized to execute the application on a specific type of physical machine, having a specific processor with a particular instruction set architecture. Such type of data may be included in the machine-dependent layers.

In some embodiments, from the input container, an instruction set architecture (ISA) of the underlying hardware architecture of a processor in a deployment environment may be determined by using an ISA discovery service. The instruction set architecture includes binary representation of a software application that runs on the processor of a computing machine supporting the instruction set architecture. Some examples of ISA may include an Intel 64-bit instruction set architecture (also referred to as x_86_64 or amd_64) or a 64-bit ARM instruction set architecture (also referred to as arm64 or aarch64). The ISA discovery service may include determining a processor type, one or more available computing resources, one or more associated instruction sets or one or more hardware configurations of an underlying hardware architecture of the deployment environment.

One or more modified input containers may be generated based on an identified instruction set architecture by selecting one or more corresponding binary versions of the underlying instruction set architecture, one or more compiler configurations associated with the input container, or one or more runtime settings of the input container. One or more machine-dependent layers are dynamically built in the one or more modified input containers and inserted in the one or more modified input containers, where the one or more machine-dependent layers are inserted in conjunction with one or more machine-neutral application layers of the input container. In some embodiments, one or more alternate machine-dependent layers in the one or more modified input containers for plurality of instruction set architectures are generated. The matching machine-dependent layer with the underlying instruction set architecture of a deployment environment may be dynamically selected, and the matching machine-dependent layer with the underlying instruction set architecture of a deployment environment may be inserted in the one or more modified input containers at the time of deployment.

In some embodiments, dynamic-composition metadata may be created in one or more modified input containers based on identified underlying instruction set architecture of a processor in a deployment environment. The dynamic-composition metadata may include one or more execution instructions, one or more environment variables, and/or one or more machine specific attributes of the underlying deployment environment. Matching machine-dependent layer of one or more machine-dependent layers with the underlying instruction set architecture of the deployment environment may be selected using the dynamic-composition metadata created for one or more modified input containers. The matching machine-dependent layer of one or more machine-dependent layers may be inserted in one or more modified input containers. Additionally, one or more modified input containers may be received comprising of a machine-neutral application layer, one or more metadata layers, or one or more specified machine-dependent metadata layers of each type of processor architecture. A new output container is rebuilt by substituting one or more machine dependent metadata layers in the one or more modified input containers for one or more machine-dependent metadata layers of a different processor architecture. The one or more modified input containers are returned as an output result. These containers are configured to be ISA-agnostic i.e. they can dynamically determine the ISA and then may use a matching machine-dependent layer of one or more machine-dependent layers for underlying ISA of the deployment environment. Consequently, the applications in the container can transparently execute on different machines having processors with instruction set architectures.

### OVERVIEW

A container is a portable and independently packaged executable code. Containerized applications are composed of isolated packages of code within a container. Containers include the dependencies that a containerized application might need to run on the operating system of a target host, such as libraries, binaries, configuration files, and frameworks. In traditional containerized applications, the container is fully composed at built time of a set of one or more layers that provide data such as applications, files, and objects; and metadata such as execution instructions, environment variables, and attributes. The fully composed and “runnable” container can then be run on container execution frameworks or within a container runtime environment. The fully composed and “runnable” container can comprise of an executable application that runs on the virtual (or physical) machine in the operating environment of a host. This application either has to be compiled into an executable application such that it adheres to the instruction set architecture of the processor (or processors) of the host operating environment, or the host operating environment may need to provide an emulation layer (such as QEMU) that enables running the application. Some examples of common machine architectures are x86_64 or amd64 (Intel 64-bit instruction set), and arm64 or aarch64 (64-bit ARM instruction set).

When machine-neutral applications are packaged into a runnable container, they can lose their portability advantage as they may have to be executed/interpreted/hosted by an executable application that can run on a particular machine supporting the instruction set architecture. Consequently, the entire container application can run on a given machine supporting the instruction set architecture. This prevents the possibility of building/deploying one “runnable” container application image that can run on different machines with different instruction sets. Therefore, developers of the container applications may have to either build multiple containers (one for each machine with a unique instruction set architecture) or use expensive emulation that can degrade the performance of applications.

In some embodiments, techniques are provided to create, manage, and/or transmute containerized applications to provide machine-neutral applications that can run on different machines with different processor architectures. The techniques streamline the containerization process across several computing environments, regardless of their underlying instruction set architectures (ISA). The instruction set architecture includes a binary representation of the software that runs on a particular processor of a hardware machine. An input container is received from a client device which includes machine neutral application layer, metadata layers or machine-dependent layers. The machine neutral application layer includes one or more machine-neutral applications such as Java/Clojure/Kotlin/JVM, JavaScript, Python, Bourne scripts, etc. The instruction set architecture information of the underlying hardware architecture of a deployment environment may be identified by using an ISA discovery service, where the ISA discovery service includes determining the processor type, available computing resources, associated instruction sets or hardware configurations.

A modified input container may be generated by customizing the input container based on the identified instruction set architecture where the customization includes selecting the corresponding binary versions of the underlying architecture, compiler configurations, or runtime settings of the input container. One or more machine-dependent layers may be dynamically built in the input container where the machine-dependent layers are inserted in the input container in conjunction with one or more shared machine-neutral application layers. Dynamic composition metadata is created, which includes execution instructions, environment variables, or machine specific attributes, and is added to the modified input container. Alternate machine-dependent layers are built in the modified input container and dynamically selects the matching machine-dependent layers with the underlying machine architecture using dynamic composition metadata at the time of deployment. One or more output containers are generated by rebuilding a new output container by substituting specified one or more machine-dependent layers for one or more machine-dependent layers of different instruction set architecture using dynamic composition metadata. The one or more output containers are configured to be ISA-agnostic containers and are returned to the client device.

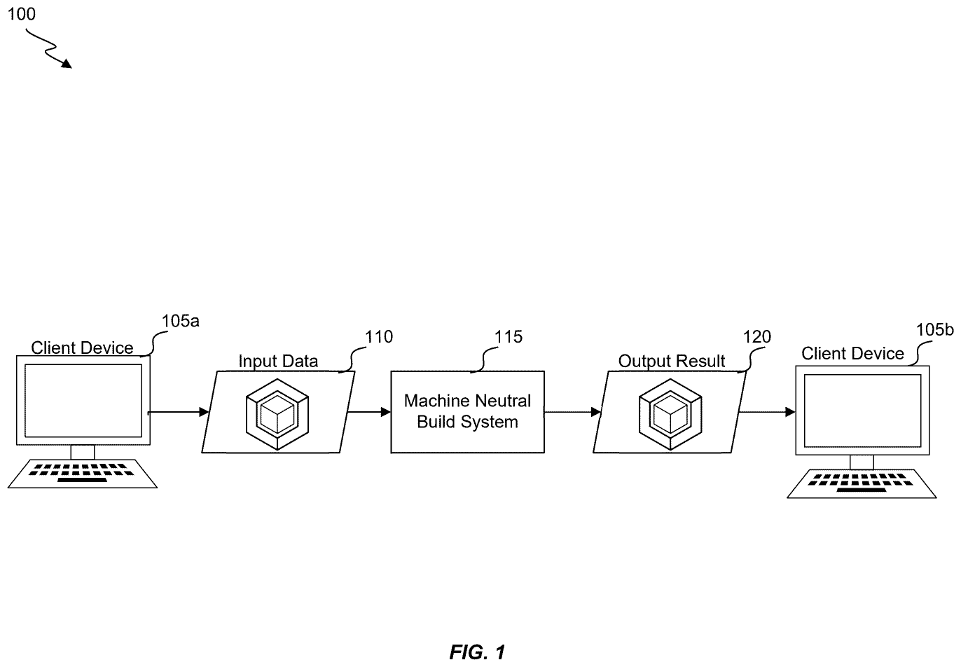

FIG. 1 is the block diagram illustrating the overview of the system that may be utilized for creating, managing, and transmuting containerized applications provide machine-neutral applications that can run on different machines with different processor architectures. A computer-implemented method 100 receives an input data 110 from a client device 105a. The input data 110 is passed on to a machine neutral build system 115 to generate an output result 120 which is then displayed to a client device 105b. 105a and 105b may be the same client devices or may comprise of different client devices comprising of one or more computer systems. The one or more computers in the client device 105a or 105b may be client terminal in communication with one or more servers, or personal digital/data assistants (PDA), laptop computers, mobile computers, internet appliances, one or two-way pagers, mobile phones, or other similar desktop, mobile or smart phones or hand-held electronic devices.

The computer system in the client device 105a or 105b of the computer-implemented method 100 includes a processing system with one or more high-speed Central Processing Unit(s) (“CPU”), processors and one or more memories. The computer system in the client device 105a or 105b may also include a memory for storing a plurality of processing modules or logical instructions that are executed by the one or more processors coupled. The computer memory that stores data may also be maintained on a computer readable medium including magnetic disks, optical disks, organic memory, and any other Volatile (e.g., Random Access Memory (“RAM)) or non-volatile (e.g., Read-Only Memory (“ROM), flash memory, etc.) mass storage system readable by the CPU. The computer readable medium includes cooperating or interconnected computer readable medium, which exists exclusively on the processing system or can be distributed among multiple interconnected processing systems that may be local or remote to the processing system.

Besides processor and memory, the computer system in the client device 105a or 105b may also include user input and output devices such as a keyboard, mouse, stylus, and a display/touchscreen. For instance, the computer system in client device 105a may provide a means for inputting the input data 110 to memory. In addition to the user input and output devices, the client device 105a and 105b may also include a communication interface which allows system 100 to be coupled to another computer, computer network, or telecommunications network using a network connection. For example, through the communication interface the system 100 can receive information, for example data objects or program instructions, from another network, or output information to another network in the course of performing method/process steps. Information, often represented as a sequence of instructions to be executed on a processor, can be received from and outputted to another network. An interface card or similar device and appropriate software implemented by, for example executed/performed on, can be used to connect system 100 to an external network and transfer data according to standard protocols. For example, various process embodiments disclosed herein can be executed on system 100 or can be performed across a network such as the Internet, intranet networks, or local area networks, in conjunction with a remote processor that shares a portion of the processing. Throughout this specification “network” refers to any interconnection between computer components including the Internet, Bluetooth, WiFi, 3G, 4G, 4GLTE, GSM, Ethernet, TCP/IP, intranet, local-area network (“LAN”), home-area network (“HAN”), serial connection, parallel connection, wide-area network (“WAN”), Fibre Channel, PCI/PCI-X, AGP, VLbus, PCI Express, Expresscard, Infiniband, ACCESS.bus, Wireless LAN, HomePNA, Optical Fibre, G.hn, infrared network, satellite network, microwave network, cellular network, virtual private network (“VPN”), Universal Serial Bus (“USB”), FireWire, Serial ATA, 1-Wire, UNI/O, or any form of connecting homogenous, heterogeneous systems and/or groups of systems together.

The machine neutral build system 115 processes the data received from the input data 110 and generates the output result 120 comprising of fully composed containers that are configured to be ISA-agnostic containers which are then communicated to the client device 105b.

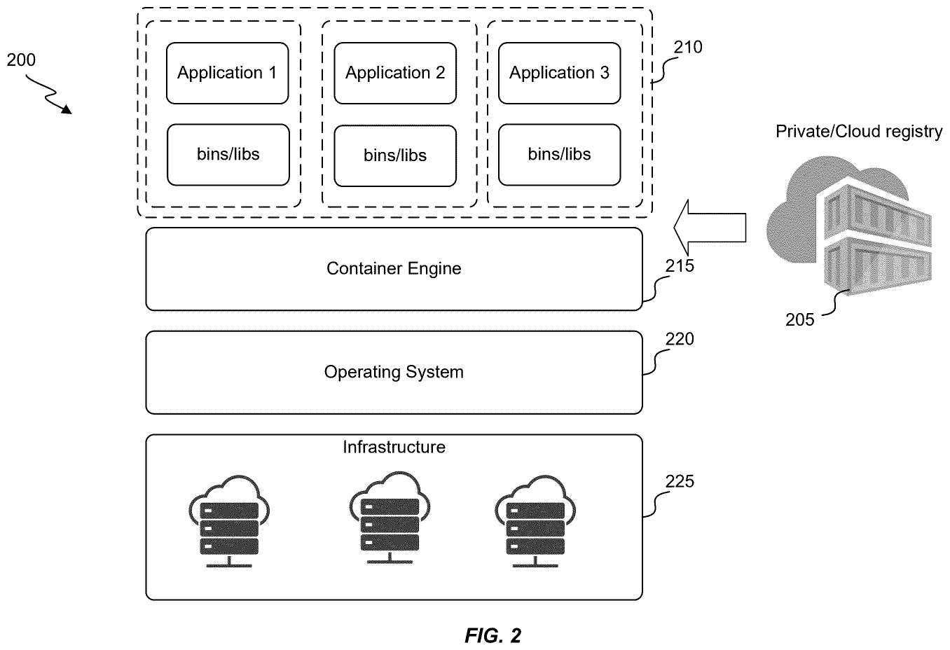

FIG. 2 is an example illustration of a containerized application deployment model in accordance with some embodiments of the disclosure. Containers are packages of software that contain the necessary elements (dependencies) to run an application in any host operating system or environment including the cloud. The containerized applications are built as lightweight executable packages comprising of libraries, binaries, configuration files, and frameworks. The containerized applications are applications run as isolated packages of code in containers. In this way, containers virtualize the operating system layer of a hardware machine and can run anywhere: from a private data center to the public cloud or even on a developer's personal laptop. Each client's application is packaged into its own container. This means that even if the applications are running on the same physical computer, they would still not interfere with the execution environments and operations of one another. Containers provide every application with the environment that it may need to transparently run. This helps avoiding conflicts between different applications that might may different configuration settings. The process of containerized application can make application development efficient and secure, as the operation and functionality of applications are decoupled from the underlying dependencies on the software and hardware of an operating environment. Containers may also avoid locking developers into any particular platform, software technology and/or vendor.

One or more containers can be received from Private/Cloud registry 205. A container registry is a repository or collection of repositories used to store and access container images. Each container includes a running process or a group of running processes that is isolated from the rest of the system. When a container is not running, it still exists as a saved file called a container image. The container image is a package of the application source code, binaries, files, and other dependencies that will live in the running container. Container images may be constructed using layered filesystems that share common files, resulting in less disk storage and efficient image downloads. When a containerized application starts, the contents of a container image are copied before they are spun into a container instance. Each container image can be used to instantiate any number of containers. The container images can be shared with others via the container registry. To promote sharing and compatibility among different platforms and tools, container images are typically created in the industry-standard Open Container Initiative (OCI) format. Container registries can support container-based application development. Container registries can connect directly to container orchestration platforms such as Docker or Kubernetes. Container orchestration provide automated management for containerized applications, especially in environments in which large numbers of containers are running on multiple hosts. In complex environments such as these, orchestrators are usually needed to handle operations such as deploying and scaling the containers. There are two types of container registries: public and private. Public registries are commonly used by individuals or small teams that want to get up and running with their registry as quickly as possible. However, as their organizations grow, this can bring more complex security issues like patching, privacy, and access control that can arise. An example public registry includes docker hub which provides access to off-the-shelf images, shared by software vendors, open-source projects and community of users. Private registries provide a way to incorporate security and privacy into enterprise container image storage, either hosted remotely or on-premises. The private registries may come with advanced security features and technical support. Cloud providers offer private image registry services. For example, Google offers the Google Container Registry, AWS provides Amazon Elastic Container Registry (ECR), and Microsoft has the Azure Container Registry.

Block 210 bundles an application's code with the files (libraries, binaries, dependencies, and related configuration files) it requires to run on any infrastructure. Applications may comprise of one or more machine-neutral applications such as Java/JVM applications, Python applications, Bourne shell scripts etc. Machine-neutral applications are designed to execute transparently on any processor architecture in a machine. Java applications are compiled to an intermediate bytecode stand, which can run in a self-contained environment called the Java Runtime Environment (JRE). Python programs may be interpreted just-in-time or precompiled into a machine-neutral bytecode, which can be executed within a Python runtime environment. When machine-neutral applications are packaged into a runnable container, they can lose their portability advantage as they may have to be executed/interpreted/hosted by an executable application that can run on a particular machine supporting the instruction set architecture. Consequently, the entire container application can run on a given machine supporting the instruction set architecture. This prevents the possibility of building/deploying one “runnable” container application image that can run on different machines with different instruction sets. Therefore, developers of the container applications may have to either build multiple containers (one for each machine with a unique instruction set architecture) or use an expensive emulation that can degrade the performance of applications.

A container engine 215 includes a software program that creates containers based on the container images. It acts as an intermediary agent between the containers and the operating system, providing and managing resources that the application requires. For example, container engines can manage multiple containers on the same operating system by keeping them independent of the underlying infrastructure and each other. The container engine may also process user requests, including command line options and image pulls. The container engine is configured to run and manage the components to deploy and operate containers. The container engine can run multiple isolated instances of containers on the same operating system kernel. Containers may perform virtualization at the operating system level, and may provide a controllable, manageable environment for running applications and dependencies. Container isolation can also enhance security by separating programs, applications and code from other applications running on the same physical host machine. The container engine may use the Open Container Initiative (OCI) container image format. OCI container images are a representation of a container and the software that runs within it. The OCI format specifies the metadata and layers in each container image and defines the layers and metadata of the container image. The OCI format defines container images comprising of a tar file for each layer and a manifest.json file that contains metadata. Examples of container engines that can be used includes Docker, CoreOS rkt, RunC, Containerd, and CRI-O. Additionally, cloud providers such as Platforms as a Service (PaaS), and container platforms have their own built-in container engines which consume docker or OCI compliant container images.

An operating system 220 is a layer in the containerization architecture below the container engine. Operating system 220 is an operating system software executing on infrastructure 225, which can be any operating system adapted to provide a containerized environment, such as Linus, other UNIX variants, Microsoft Windows, Windows Server, Mac OS, Apple IOS, and/or Google Android, among others. An example operating system used in containers with on-premises computers may include Linux. In cloud computing, developers may use cloud services such as AWS-EC2 to run containerized applications in Amazon web services operating environment. The Operating system layer may comprise of a full virtual operating system where the container still shares a host kernel but may run a full init system which allows the container to run multiple processes. Init is the first process that runs when an example operating system such as Unix-based system is booted up. Its role is to start up and manage system processes and services required for the operating system's functioning. Infrastructure 225 includes a hardware layer of the container model. It refers to the physical computer or server that runs the containerized applications. The hardware includes a CPU processor, storage which may include a PC, laptop, mobile device, a chip or a device with memory and/or disk. Hardware may also include use of cloud infrastructure (IaaS) or PaaS.

The containers comprising of applications, container engine and operating system can be created using a variety of technologies. Example technologies that can be used to create and deploy containers include Docker, Linux, or Kubernetes. Docker is an open-source container runtime that allows software developers to build, deploy, and test containerized applications on various platforms. Docker containers are self-contained packages of applications and related files that are created with the docker framework. Linux is an open-source operating system with built-in container technology. Linux containers are self-contained environments that allow multiple Linux-based applications to run on a single host machine. Software developers use Linux containers to deploy applications that write or read large amounts of data. Linux containers do not copy the entire operating system to their virtualized environment. Instead, the containers comprise of necessary functionalities allocated in the Linux namespace. Kubernetes is an open-source container system that developers use to deploy, scale, and manage a vast number of microservices. It has a declarative model that enables automating the containers. The declarative model ensures that Kubernetes takes the appropriate action to fulfil the requirements based on the configuration files. Containers are different from Virtual Machines (VMs). Containers virtualizes the operating system (OS) while VMs virtualize the underlying hardware. Containers uses the host operating system's kernel while VMs installs the kernel necessary for the full OS virtualization. Containers use storage volumes i.e., filesystems mounted as files on the host OS while VMs store data on virtual hard disks (VHD).

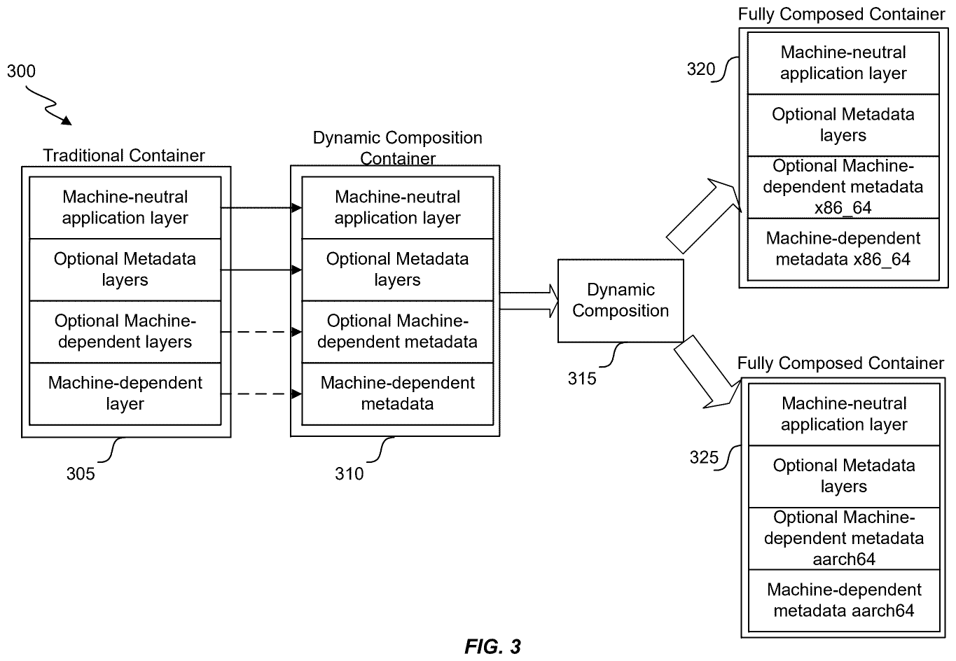

FIG. 3 illustrates the steps of generating fully composed containers with machine-dependent layers using a dynamic composition process in accordance with some embodiments of the disclosure. The example embodiment may be implemented by system 300 which includes receiving a traditional container 305, a dynamic composition container 310, a dynamic composition 315 and fully composed containers 320 and 325. A traditional container 305 is received from the client device 105a. The traditional container includes a machine-neutral application layer comprising machine-neutral applications such as Java/JVM applications, Python applications, Bourne shell scripts etc. Machine-neutral applications are designed to execute transparently on any processor architecture in a machine. For machine-neutral applications, developers may need not worry about the executing environment or the processor architecture of a machine on which their software applications will be executed. For machine-dependent applications, developers may need to specify which machine is going to be used for running the software application. For example, if a developer wants to run an application developed in the C language on Windows XP, then the developer has to compile the application code in a windows compatible C compiler. Similarly, if the developer wants to run the same application, developed in the C language, on UNIX or Linux platform, the developer has to compile the same application code in a UNIX or Linux compatible C compiler. Machine-neutral applications such as Java applications are compiled to an intermediate bytecode stand, which can run in a self-contained environment called the Java Runtime Environment (JRE). Python programs may be interpreted just-in-time or precompiled into a machine-neutral bytecode, which can be executed within a Python runtime environment.

In addition to the machine-neutral application layer, the traditional container includes a metadata layer. The metadata layer includes descriptions of container image such as container image name, tags, labels, execution instructions, environment variables, exposed ports, volumes, entry point and attributes. The metadata provides information about the container image and how to use it. The traditional container includes one or more machine-dependent layers. Machine-dependent layers comprise the information that may be used to run the application on a specific type of hardware, such as a specific processor with a specific instruction set architecture.

The dynamic composition container 310 is created using the traditional container 305. The dynamic composition container includes machine-neutral application layer, metadata layers and one or more machine-dependent metadata layers. The machine-neutral application layer and metadata layers in dynamic composition container 310 are same as the machine-neutral application layer and metadata layers in the traditional container 305. The machine-dependent layers in the traditional container are replaced with machine-dependent metadata layers comprising of dynamic-composition metadata in the dynamic composition container. Machine-dependent layers are instead referenced with the dynamic-composition metadata in the metadata layers that indicate the container specifications for deploying the containerized applications. The metadata layers are used to indicate how to fully compose a containerized application with its machine-dependent layers that are added at the time of the deployment. The metadata layers may be manually or programmatically inserted into the container specification as it is created or edited. In an example embodiment, metadata layers denoting machine-dependent requirements may be created using a label attribute to specify the information, which may be retrieved dynamically, at the time of deploying the containerized application. For example, a Clojure application which requires “clojure:temurin-21-lein” to provide the JVM/JRE for the machine-neutral JAR application, may instead supply LABEL dynamic-dep=“FROM clojure:temurin-21-lein; RUN/some/commands; CMD\“java\”, \“-jar\”, \“/path/to/app\””. The method may utilize the existing metadata tagging capabilities of container composition, such that these containers may be recognized by standard container handling systems.

The dynamic composition 315 receives the dynamic composition container 310 and generates fully composed containers 320 and 325. The dynamic composition 315 may employ a dynamic-composition aware deployment engine that dynamically scans the container for machine-dependent metadata comprising of dynamic-composition metadata. Subsequently, it attempts to retrieve/build these layers at run-time before deploying the containerized application. The dynamic-composition aware deployment engine deploys an ephemeral instance of a fully resolved container. Multiple fully resolved containers may be generated for different machine-dependent deployment instances from the same dynamic-composition container. A method to make container engines “dynamic-composition-aware” may comprise of steps such as scanning the dynamic-composition metadata in candidate containers before deployment, and subsequently new fully composed containers can be generated on-the-fly based on the instructions and requirements contained within the dynamic-composition metadata layers. The container engine can retrieve specified layers from their locations in available registries and builds the new (potentially ephemeral) container just before its deployment. The dynamic composition may also determine which instruction set architecture (ISA) is supported by the processor (or processors) of the underlying machine. The ISA defines the supported data types, the registers, main memory management methods, virtual memory management method, types and format of machine instructions that a microprocessor can execute, and the input/output model of multiple ISA implementations.

The dynamic composition 315 determines the ISA of the underlying machine and generates fully composed containers 320 and 325 accordingly. In an example embodiment, if the dynamic composition determines that the underlying machine architecture is based on x86_64 or amd64 (Intel 64-bit instruction set), the fully composed container 320 is generated that includes one or more machine dependent metadata for x86_64 or amd64 (Intel 64-bit instruction set). The x86-64 (also called x86_64, x64, or amd64) is the 64-bit CPU architecture that is used in Intel and AMD processors. It is an extension to the 32-bit x86 (i386) architecture. The x86-64 architecture is used in the CPUs for home computers and servers, whereas the ARM64 architecture is in use in smartphones. The x86-64 is designed with a complex instruction set computing (CISC) approach. CISC includes a set of different instructions that can perform complex computing and data processing operation in a single instruction. Similarly, in another example embodiment if the dynamic composition determines that the underlying machine architecture is based on arm64 or aarch64 (64-bit ARM instruction set), the fully composed container 325 is generated that includes one or more machine dependent metadata for arm64 or aarch64 (64-bit ARM instruction set). The ARM instruction set based CPUs are a family of processors based on reduced instruction set computer (RISC) architecture.

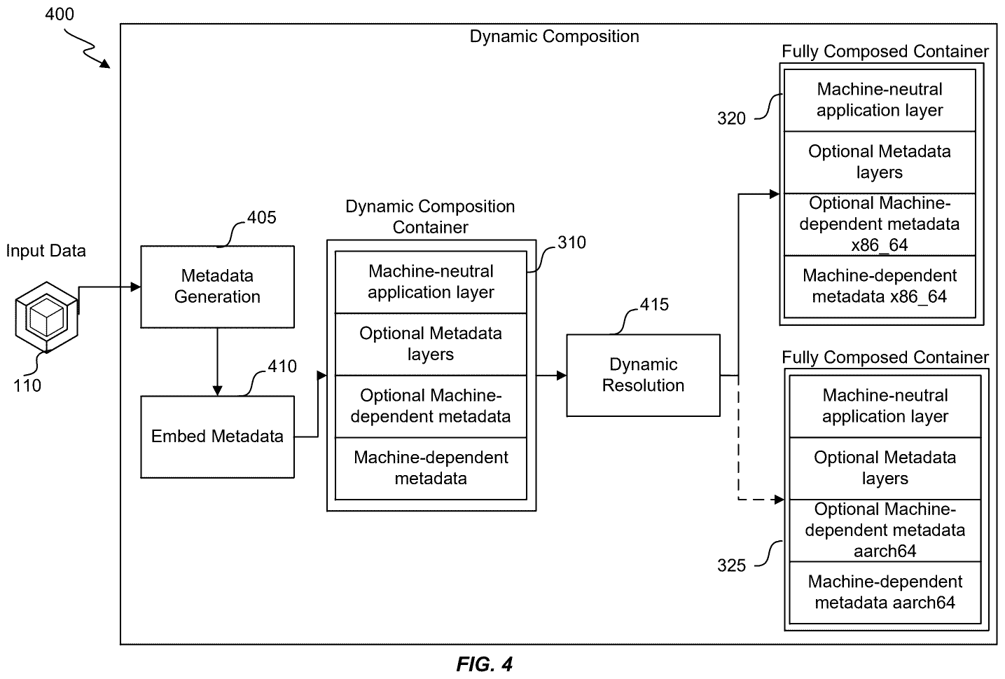

FIG. 4 illustrates the steps of generating fully composed containers with machine-dependent layers using a step-by-step process including receiving input containers, generating and embedding metadata and dynamic resolution. The example embodiment may be implemented by system 400 which includes receiving an input data 110, metadata generation 405, embed metadata 410, the dynamic composition container 310, a dynamic resolution 415 and fully composed containers 320 and 325.

The input data 110 is received from the client device 105a and may include one or more traditional containers 305. The traditional container includes the machine-neutral application layer, metadata layer and one or more machine-dependent layers. Metadata generation 405 generates metadata that can be inserted into an input container. The metadata of a container metadata enables using OpenShift Container Platform allows developers to use the container images. OpenShift Container Platform allows to access the services of container development platforms such as Docker and Kubernetes through API calls. OpenShift Container Platform provides a self-service platform to create, modify, and deploy applications on demand. The metadata is generated to provide descriptions of the container images, where descriptions may specify detailed information about the service or functionality that a container image provides. Metadata generation may use label instructions to define container image metadata. Labels are similar to environment variables in the sense that they also comprise of key value pairs that define the image of a container. Labels are different from environment variables in the sense that they are invisible to a running application. Moreover, they can also be used for fast look-up of images of containers. The label may also include lists of tags represented as list of comma-separated values. The tags are a way to categorize the container images into broad areas of functionality e.g. MongoDB, mongodb24, NoSQL etc. The metadata may include build information of a container, such as git tags and release dates, credit images to 1 or more authors/maintainers, display license information to determine if it's MIT, GPLv2 etc., or description of resources the container image might need to work properly.

The embed metadata 410 annotates the input container with the generated metadata in the machine-dependent metadata layers. The embed metadata may utilize the existing metadata tagging capabilities of container composition, such that these containers may be recognized by a standard container handling system. The metadata may be manually or programmatically inserted into the container specification once it is created or edited. The embed metadata may also insert information such as execution instructions, environment variables, and attributes with respect to underlying machine architecture in the input container. In an example embodiment, the embed metadata may bundle the generated metadata comprising of applications' configuration properties within the executable jar, where application code uses JAVA language. The application configuration metadata can be generated from classes annotated with @ConfigurationProperties by using the spring-boot-configuration-processor library. The library includes a Java annotation processor that is used when the project is compiled to generate the configuration metadata file, stored in the uber-jar as META-INF/spring-configuration-metadata.json. At runtime, the metadata is packaged either as a separate companion artifact jar or as a configuration label inside the application's container image. The configuration metadata files provide details of the supported configuration properties of the application. The embed metadata generates the dynamic composition container 310 which includes machine-neutral application layer, metadata layer and one or more machine-dependent metadata layers.

The dynamic resolution 415 receives the dynamic composition container 310 and examines the machine-dependent metadata layers. Before deployment, the dynamic resolution looks for dynamic-composition metadata in machine-dependent metadata layers in the container and tries to obtain or create these layers dynamically. The dynamic resolution then deploys a potentially ephemeral instance of the fully resolved container. The fully resolved container also includes additional metadata specifying which layers have been resolved from dynamic-dependency metadata layers, such that these may be replaced later based on the underlying machine architecture. The resulting container may be ephemeral and discarded once its deployment lifetime has ended. Multiple fully resolved containers may be generated for different machine-dependent deployment instances from the same dynamic-composition container. The dynamic resolution employs a logic to enable containers to be “dynamic-composition-aware”, such that the dynamic-composition metadata in the machine-dependent layers can be scanned in the containers before deployment, and subsequently new fully composed containers are generated on-the-fly based on the instructions and requirements within the machine-dependent metadata layers. Just prior to deployment, the dynamic resolution may construct the new, possibly transient container and retrieve particular layers from the locations they currently reside in the available registries.

The dynamic resolution determines the ISA of the underlying machine and generates fully composed containers 320 and 325 compatible with the ISA. In an example embodiment, if the dynamic composition determines that the underlying machine architecture is based on x86_64 or amd64 (Intel 64-bit instruction set), the fully composed container 320 is generated that includes one or more machine dependent metadata for x86_64 or amd64 (Intel 64-bit instruction set). Similarly, in another example embodiment if the dynamic composition determines that the underlying machine architecture is based on arm64 or aarch64 (64-bit ARM instruction set), the fully composed container 325 is generated that includes one or more machine dependent metadata for arm64 or aarch64 (64-bit ARM instruction set).

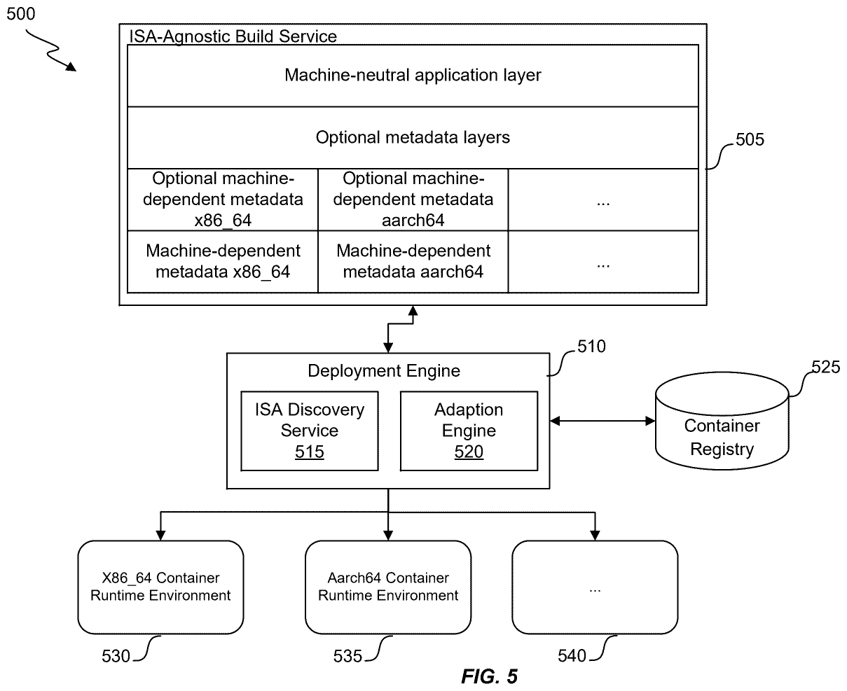

FIG. 5 illustrates the block diagram of generating machine architecture specific container runtime environment using ISA discovery service and adaption engine in accordance with some embodiments of the disclosure. The example embodiment may be implemented by system 500 which includes an ISA-agnostic build service 505, a deployment engine 510, a container registry 525, container runtime environments 530, 535 and 540. The deployment engine 510 further includes an ISA discovery service 515 and an adaption engine 520.

The ISA-agnostic build service 505 builds a container that includes machine-neutral application layer and metadata layer which are same as the machine-neutral application layer and metadata layer in traditional container 305. The ISA-agnostic build service builds container images comprising of multiple machine-dependent entry point layers as “alternates” for each machine architecture at the time of image creation in conjunction with one or more shared machine-neutral application layers within the same image. In an example embodiment, the ISA-agnostic build service may insert one or more machine dependent metadata layers for x_86_64 architecture (Intel 64-bit instruction set), one or more machine dependent metadata layers for aarch64 architecture (64-bit ARM instruction set) or x_86_32 architecture (Intel 32-bit instruction set) etc. The ISA-agnostic build service employs methods to locate alternate machine-dependent entry point layers and automatically select the ones matching the machine type at the time of deployment of a container. Multiple “alternate” entry point layers can be scanned, each tagged with the dynamic-composition metadata describing the ISA of their target machine in the deployment environment. An Entry point is the sets of executables that will run when the container is initiated. Entry point serves as the starting point for the container's runtime process. When container image is created, the entry point instructions (or commands) are executed by default.

The deployment engine 510 receives the container with one or more machine dependent metadata layers and may further include ISA discovery service 515 and adaption engine 520. The ISA discovery service 515 dynamically discovers the ISA information of the deployment environment. It employs techniques to enable containers to autonomously detect the ISA of the underlying hardware during deployment. It allows the container to adapt its architecture and runtime requirements to make it compatible with the target machine in the deployment environment, removing the dependencies associated with supporting a diverse set of ISAs. Consequently, a container is configured as instruction set architecture (ISA) agnostic for deployment and machine-dependent layers can be dynamically built at the deployment time. The deployment engine are made “alternate-entry point-aware” by scanning the dynamic-composition metadata in machine-dependent layer in candidate containers before deployment and selecting the appropriate layer for the matching the ISA of a target machine, and then loading the application by executing entry point instructions. Additional alternate machine-dependent entry point layers are ignored. The ISA discovery service autonomously detects the ISA of the target environment at the time of deployment. It then configures the container in real time, compiling and optimizing it for the detected ISA.

The ISA discovery service detects the ISA of the target environment at the deployment stage by determining the processor type, available computing resources, associated instruction sets, and other relevant hardware specifications. The adaption engine 520 receives the discovered ISA information from the ISA discovery service and customizes the container's binaries and dependencies to make them compatible with the ISA of a target machine. This involves selecting the appropriate binary versions, compiler optimizations, and runtime settings. The adaption engine may access the information for specific container images from container registry 525. The container registry is a repository or collection of repositories, which can be public or private, used to store and access container images. Container registries can connect directly to container orchestration platforms such as Docker or Kubernetes. Container registries may store multiple repositories of container images, as well as storing API paths and access control rules. Each image within a repository represents a different deployment version of the same container that is compatible with its relevant deployment environment. For example, in container registry docker hub, nginx is the name of the repository that contains different versions of the docker image for open-source web server installation NGINX. A specific image is identified by either its tag or its own unique reference.

Container registries can be of public or private types. Public registries are commonly used by individuals or small teams that want to use the registry and quickly load their container. However, as the organizations grow, security provision might be enabled by patching, privacy, and access control processes. Private registries provide a way to incorporate advanced security and privacy capabilities in an enterprise container image storage that is either hosted remotely or on-premises. A private registry's features allow organizations to internally access container images in a secure yet efficient manner. Multiple authentication systems verify the container images stored in the registry. For example, the image has to be digitally signed by the person who is uploading it to get it pushed into the registry. This prevents unauthorized user uploads. Cloud providers offer private image registry services. For example, Google offers the Google Container Registry, AWS provides Amazon Elastic Container Registry (ECR), and Microsoft has the Azure Container Registry. Container registries may also provide Web interfaces that developers can use to manage container images and configure access controls for them. Moreover, they can apply search filters on container images. Command line tools (or Kubernetes configuration files) can be used to run images in production with the help of a registry.

The deployment engine generates machine specific runtime environments which are configured to be ISA-agnostic containers. For example, the deployment engine may generate x_86_64 container runtime environment 530 for the machine with Intel 64-bit instruction set architecture or may generate aarch64 container runtime environment 535 for the machine with 64-bit ARM instruction set architecture or other container runtime environment 540 for a machine with a different instruction set architecture. The container runtime environment allows containers to run on a target host system. Container runtime environments interacts with the host operating system and may leverage various features of the OS, like namespaces and cgroups, to isolate and manage resources for each container. This isolation between processes inside a container provides a secure environment where the crashing of one container will not affect the other containers running on the host. Container runtime environment may also help in equitable yet efficient resource management. As a result, no container can monopolize resources such as CPU, memory, and I/O, especially in multi-tenant environments.

Container runtime environments are classified as low-level runtimes, high-level runtimes, and specialized runtimes. Low-level container runtimes are minimal runtimes that interact directly with the OS kernel and relies on the host OS security features. High-level runtimes offer additional functionalities beyond basic execution and are integrated with orchestration platforms for providing additional security features and services. High-level runtimes are tailored for specific platforms such as Kubernetes, edge computing, or even Internet of Things (IoT) platforms. The system that generates ISA-agnostic containers is seamlessly integrated with existing Continuous Integration/Continuous Deployment (CI/CD) pipelines. Consequently, manual interventions are eliminated and builds for various ISAs are automatically created and deployed. Continuous integration (CI) refers to the practice of automatically integrating code changes into a shared source code repository. Continuous delivery and/or deployment (CD) is a two-part process that refers to the integration, testing, and delivery of code changes. Continuous delivery does not provide automatic production deployment, and in comparison, continuous deployment automatically releases the updates into the production environment.

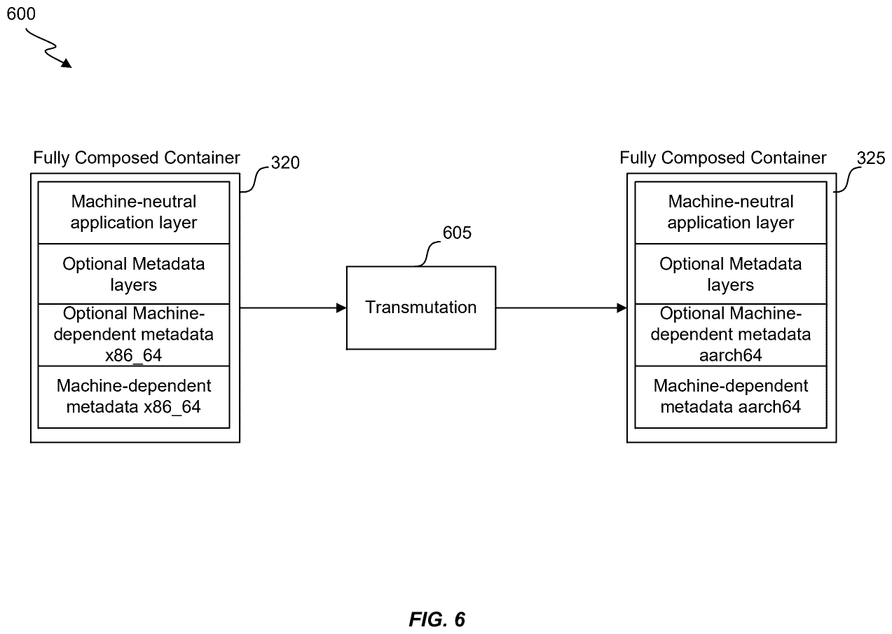

FIG. 6 illustrates a process of transmuting fully composed container with machine-dependent metadata layers of one example instruction set architecture into fully composed container that is compatible with a different instruction set architecture in accordance with some embodiments of the disclosure. The example embodiment may be implemented by system 600 which includes a fully composed container 320 received as input, a transmutation 605 that generates a different fully composed container 325.

The fully composed container 320 is received as an input and includes machine-neutral application layer, metadata layers and one or more machine-dependent metadata layer. Machine-neutral applications may include applications such as Java/JVM applications, Python applications, Bourne shell scripts, and others, which are designed to execute on different underlying machines containing processors with various ISAs. The metadata layer includes descriptions of container image such as container image name, tags, labels, execution instructions, environment variables, exposed ports, volumes, entry point and attributes. The metadata provides information about the container image and how to load and execute it. One or more machine-dependent metadata layers define the ISAs of the target processors of machines in the deployment environment. The metadata layers enable to fully compose an application with its machine-dependent layers that are dynamically added at the time of deploying the application. The metadata layers may be manually or programmatically inserted into the container specification when it is created or edited. In the example embodiment, the fully composed container may include one or more machine dependent metadata for x86_64 or amd64 (Intel 64-bit instruction set). The x86-64 (also called x86_64, x64, or amd64) is the 64-bit CPU architecture that is used in Intel and AMD processors.

Transmutation 605 receives a fully composed container of a specific architecture and looks for dynamic-composition metadata layers in the fully composed container. The transmutation process recomposes a new fully composed output container 325 by substituting specified machine-dependent layers of a specific instruction set architecture with different machine-dependent layers of different instruction set architectures according to the dynamic-composition metadata. The transmutation process includes methods that can read container image data and metadata layers, scan for pertinent dynamic-composition layers in the container and generate new containers by substituting machine-independent layers for one ISA with machine dependent layers for a different ISA that are available locally or via available container registries. In an example embodiment, fully composed output container generated by the transmutation process may include one or more machine dependent metadata for arm64 or aarch64 (64-bit ARM instruction set).

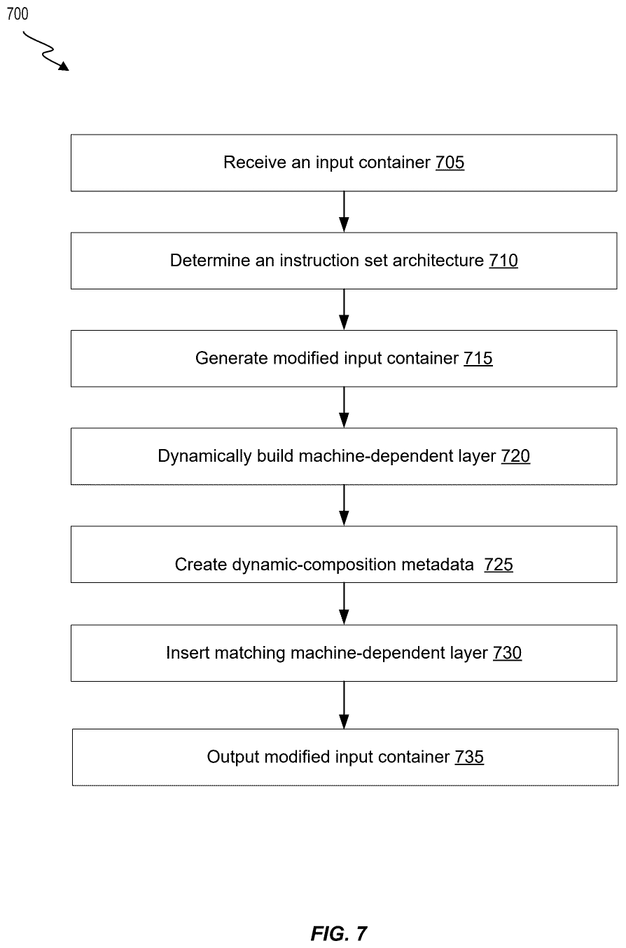

FIG. 7 illustrates an example flow of a method for obtaining the final output result of fully composed modified input container configured to be machine architecture neutrality underneath machine-neutral applications in accordance with some embodiments of the present disclosure. Referring to FIG. 7, at block 705, an input container is received from the client device 105a. The client device may be client terminal in communication with one or more servers, or personal digital/data assistants (PDA), laptop computers, mobile computers, internet appliances, one or two-way pagers, mobile phones, or other similar desktop, mobile or smart phones or hand-held electronic devices or cloud environments. The input container includes machine-neutral application layer, metadata layer and/or one or more machine-dependent layers. Machine-neutral applications such as Java/JVM applications, Python applications, Bourne shell scripts, and others, which are designed to execute on different underlying machines with different ISAs. The metadata layer includes descriptions of container image such as container image name, tags, labels, execution instructions, environment variables, exposed ports, volumes, entry point and attributes. The metadata provides information about the container image and how to use it. One or more machine-dependent layers comprise of the information that may be used to run the application on a specific type of hardware, such as a specific processor with a specific instruction set architecture.

At block 710, an instruction set architecture of the underlying hardware machine is determined by using an ISA discovery service. The instruction set architecture includes binary representation of a software that runs on a machine having a processor with a specific ISA. Example instruction set architecture includes Intel 64-bit instruction set architecture or a 64-bit ARM instruction set architecture. The ISA discovery service includes determining the processor type, one or more available computing resources, one or more associated instruction sets or one or more hardware configurations of the underlying hardware architecture of a deployment environment. At block 715, one or more modified input containers are generated (e.g., using an Adaptation Engine) based on the identified instruction set architecture by selecting one or more corresponding binary versions of instruction set architecture, one or more compiler configurations associated with the input container, or one or more runtime settings of the input container. At block 720, one or more machine-dependent layers are dynamically built (e.g., using an ISA-Agnostic Build Service) in the one or more modified input containers and one or more machine-dependent layers are inserted into the one or more modified input containers where the one or more machine-dependent layers are inserted in conjunction with one or more machine-neutral application layers of the input container. In one of the embodiments, the one or more alternate machine-dependent layers can be built in the one or more modified input containers for plurality of instruction set architectures. The matching machine-dependent layer with the underlying instruction set architecture of a deployment environment may be dynamically selected and the matching machine-dependent layer may be inserted in one or more modified input containers at the time of the deployment.

At block 725, dynamic-composition metadata is created in one or more modified input containers based on identified underlying instruction set architecture of a deployment environment. The dynamic-composition metadata includes one or more execution instructions, one or more environment variables, or one or more machine specific attributes of the underlying deployment hardware machine. The dynamic-composition metadata layers may be manually or programmatically inserted into the container specification when it is created or edited. In one of the embodiments of the present disclosure, the dynamic composition process scans the container for dynamic-composition metadata layers, then attempts to retrieve/build these layers at run-time before deployment. An ephemeral instance of a fully resolved container can then be deployed. Multiple fully resolved containers may be generated for different machine-dependent deployment instances from the same dynamic-composition container. Dynamic-composition metadata can be scanned in candidate containers before deployment, and new fully composed containers are generated on-the-fly based on the instructions and requirements within the dynamic-composition metadata layers. At block 730, a matching machine-dependent layer is selected for one or more machine-dependent layers with the underlying instruction set architecture of a processor in the deployment environment using the dynamic-composition metadata created in one or more modified input containers. The matching machine-dependent layer of one or more machine-dependent layers may be inserted in one or more modified input containers. In one of the embodiments of the present disclosure, one or more modified input containers are received that includes machine-neutral application layer, one or more metadata layers, or one or more specified machine-dependent metadata layers of one architecture. A new output container is rebuilt by substituting one or more machine dependent metadata layers in one or more modified input containers for different one or more machine-dependent metadata layers of a different instruction set architecture. The new output container is configured to dynamically discover the underlying ISA and adapt to it, before it is returned as an output. At block 735, one or more modified input containers are returned as an output. One, more or all of blocks 725, 730 and 735 may be performed in part or in full by ISA-Agnostic Build Service, Adaption Engine, or a combination of the same (e.g., interactive processing of the same).

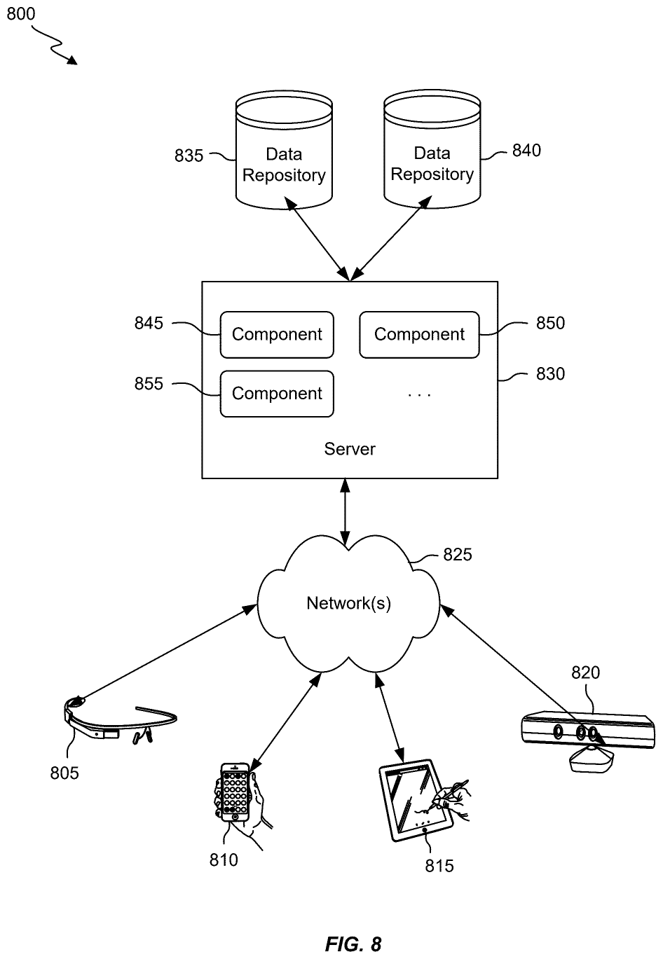

FIG. 8 depicts a simplified diagram of a distributed system 800 for implementing system 100 of FIG. 1. In the illustrated embodiment, distributed system 800 includes one or more subject computing devices 805, 810, 815, and 820, coupled to a server 830 via one or more network(s) 825. Subjects computing devices 805, 810, 815, and 820 may be configured to execute one or more applications.

In various aspects, server 830 may be adapted to run one or services or software applications that enable techniques for creating, managing, and transmuting containerized applications to provide machine architecture neutrality underneath machine-neutral applications. In certain aspects, server 830 may also provide other services or software applications that can include non-virtual and virtual environments. In some respects, these services may be offered as web-based or cloud services, such as under a Software as a Service (SaaS) model to the users of subject computing devices 805, 810, 815, and/or 820. Users operating subject computing devices 805, 810, 815, and/or 820 may, in turn, utilize one or more subject applications to interact with server 830 to utilize the services provided by these components. Furthermore, subject computing devices 805, 810, 815, and/or 820 may, in turn, utilize one or more subject applications for creating, managing, and transmuting containerized applications to provide machine architecture neutrality underneath machine-neutral applications.

In the configuration depicted in FIG. 8, server 830 may include one or more components 845, 850, and 855 that implement the functions performed by server 830. These components may include software components that may be executed by one or more processors, hardware components, or combinations thereof. It may be appreciated that various system configurations are possible, which may be different from distributed system 800. The embodiment shown in FIG. 8 is thus one example of a distributed system for implementing an embodiment system and is not intended to be limiting.

Users may use subject computing devices 805, 810, 815, and/or 820 for creating, managing, and transmuting containerized applications to provide machine architecture neutrality underneath machine-neutral applications in accordance with the teachings of this disclosure. A subject device may provide an interface that enables a user of the subject device to interact with the subject device. The subject device may also output information to the user via this interface. Although FIG. 8 depicts only four subject computing devices, any number of subject computing devices may be supported.

The subject devices may include various types of computing systems such as portable handheld devices, general purpose computers such as personal computers and laptops, workstation computers, wearable devices, gaming systems, thin subjects, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head-mounted displays and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The subject devices may be capable of executing various applications such as various Internet-related apps and communication applications (e.g., E-mail applications, short message service (SMS) applications) and may use various communication protocols.

Network(s) 825 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 1025 can be a Local Area Network (LAN), network based on Ethernet, Token-Ring, a Wide-Area Network (WAN), the Internet, a virtual network, a Virtual Private Network (VPN), an intranet, an extranet, a Public Switched Telephone Network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 830 may include one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 830 can include one or more virtual machines running virtual operating systems, or other computing architectures involving virtualization such as one or more flexible pools of logical storage devices that can be virtualized to maintain virtual storage devices for the server. In various aspects, server 830 may be adapted to run one or more services or software applications that provide the functionality described in the foregoing disclosure.

The computing systems in server 830 may run one or more operating systems including any of those discussed above, as well as any commercially available server operating system. Server 830 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation, those commercially available from Oracle®, Microsoft®, Sybase®, IBM® (International Business Machines), and the like.

In some implementations, server 830 may include one or more applications to implement various algorithms. The data in the input data 110 of FIG. 1 may include data of various forms such as text data, audio data, time-series data, and real-time data. As an example, in a case where the data samples are text or image that may include but are not limited to, Twitter® feeds, Facebook® updates, or real-time updates received from one or more third-party information sources and continuous data streams, which may include real-time events related to sensor data applications, financial tickers, network performance measuring tools (e.g., network monitoring and traffic management applications), clickstream analysis tools, automobile traffic monitoring, and the like. Server 830 may also include one or more applications to display the output of various processes of system 100 via one or more display devices of subject computing devices 805, 810, 815, and 820.

Distributed system 800 may also include one or more data repositories 835, and 840. These data repositories may be used to store data in database and other information in certain aspects. Data repositories 835, and 840 may reside in a variety of locations. For example, a data repository used by server 830 may be local to server 830 or may be remote from server 830 and in communication with server 830 via a network-based or dedicated connection. Data repositories 835, and 840 may be of different types. In certain aspects, a data repository used by server 830 may be a database, for example, a relational database, such as databases provided by Oracle Corporation® and other vendors. One or more of these databases may be adapted to enable storage, update, and retrieval of data to and from the database in response to Structured Query Language (SQL)-formatted commands.

In certain aspects, one or more data repositories 835, and 840 may also be used by applications to store application data. The data repositories used by applications may be of different types such as, for example, a key-value store repository, an object store repository, or a general storage repository supported by a file system.

In certain aspects, the techniques for creating, managing, and transmuting containerized applications to provide machine architecture neutrality underneath machine-neutral applications described in this disclosure may be offered as services via a cloud environment. FIG. 8 is a simplified block diagram of a cloud-based system environment in which various services of server 830 of FIG. 8 may be offered as cloud services, in accordance with certain aspects. In the embodiment depicted in FIG. 8, subject computing devices 805 may provide one or more cloud services that may be requested by users using one or more subject computing devices 810, 815, and 820. Subject computing devices 805 may comprise one or more computers and/or servers that may include those described for server 830. The computers in subject computing devices 805 may be organized as general-purpose computers, specialized server computers, server farms, server clusters, or any other appropriate arrangement and/or combination.

Network(s) 825 may facilitate communication and exchange of data between subject computing devices 810, 815, and 820 and subject computing devices 805. Network(s) 825 may include one or more networks. The networks may be of the same or different types. Network(s) 825 may support one or more communication protocols, including wired and/or wireless protocols, for facilitating communications.

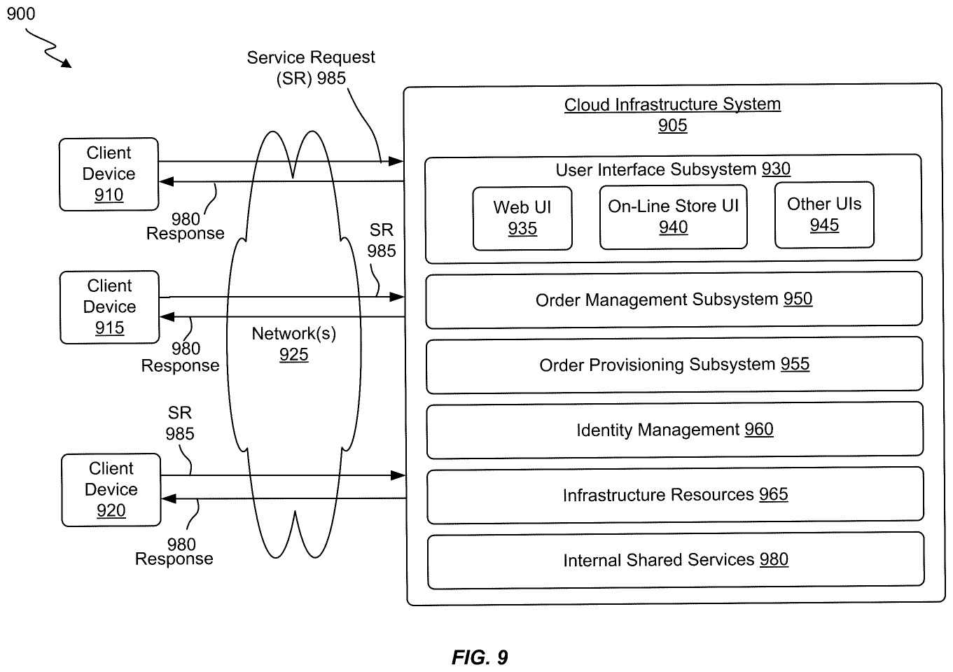

The embodiment depicted in FIG. 9 is only one example of a cloud infrastructure system and is not intended to be limiting. It should be appreciated that, in some other respects, cloud infrastructure system 905 may have more or fewer components than those depicted in FIG. 9, may combine two or more components, or may have a different configuration or arrangement of components. For example, although FIG. 9 depicts three subject computing devices, any number of subject computing devices may be supported in alternative aspects.

The term cloud service is generally used to refer to a service that is made available to users on demand and via a communication network such as the Internet by systems (e.g., cloud infrastructure system 905) of a service provider. Typically, in a public cloud environment, servers and systems that make up the cloud service provider's system are different from the subject's own on-premises servers and systems. The cloud service provider's systems are managed by the cloud service provider. Subjects can thus avail themselves of cloud services provided by a cloud service provider without having to purchase separate licenses, support, or hardware and software resources for the services. For example, a cloud service provider's system may host an application, and a user may, via a network 925 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation® of Redwood Shores, California, such as middleware services, database services, Java cloud services, and others.

In certain aspects, cloud infrastructure system 905 may provide one or more cloud services using different models such as under a Software as a Service (SaaS) model, a Platform as a Service (PaaS) model, an Infrastructure as a Service (IaaS) model, and others, including hybrid service models. Cloud infrastructure system 905 may include a suite of applications, middleware, databases, and other resources that enable the provision of the various cloud services.

A SaaS model enables an application or software to be delivered to a subject over a communication network like the Internet, as a service, without the subject having to buy the hardware or software for the underlying application. For example, a SaaS model may be used to provide subjects access to on-demand applications that are hosted by cloud infrastructure system 905. Examples of SaaS services provided by Oracle Corporation® include, without limitation, various services for human resources/capital management, subject relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a subject as a cloud service to provide elastic compute and storage capabilities. Various IaaS services are provided by Oracle Corporation®.

A PaaS model is generally used to provide, as a service, platform, and environment resources that enable subjects to develop, run, and manage applications and services without the subject having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, highly available, and secure manner. For example, a subject, via a subscription order, may order one or more services provided by cloud infrastructure system 905. Cloud infrastructure system 905 then performs processing to provide the services requested in the subject's subscription order. Cloud infrastructure system 905 may be configured to provide one or even multiple cloud services.

Cloud infrastructure system 905 may provide cloud services via different deployment models. In a public cloud model, cloud infrastructure system 905 may be owned by a third-party cloud services provider and the cloud services are offered to any general public subject, where the subject can be an individual or an enterprise. In certain other aspects, under a private cloud model, cloud infrastructure system 905 may be operated within an organization (e.g., within an enterprise organization) and services provided to subjects that are within the organization. For example, the subjects may be various departments of an enterprise, such as the Human Resources department, the payroll department, etc. or even individuals within the enterprise. In certain other aspects, under a community cloud model, the cloud infrastructure system 905 and the services provided may be shared by several organizations in a related community. Various other models, such as hybrids of the above-mentioned models may also be used.

Subject computing devices 910, 915, and 920 may be of several types (such as cloud infrastructure system 905, 910, 915, and 920 depicted in FIG. 9) and may be capable of operating one or more subject applications. A user may use a subject device to interact with

Cloud Infrastructure System 905, such as to request a service provided by Cloud Infrastructure System 905.

As depicted in the embodiment in FIG. 9, cloud infrastructure system 905 may include infrastructure resources 975 that can be utilized for facilitating the provision of various cloud services offered by cloud infrastructure system 905. These services include 705, 710, 715, 720, 725, 730 and 735 as shown in FIG. 7. Infrastructure resources 975 may include, for example, processing resources, storage or memory resources, networking resources, and the like.

In certain aspects, to facilitate efficient provisioning of these resources for supporting the various cloud services provided by cloud infrastructure system 905 for different subjects, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 905 may itself internally use services 970 that are shared by different components of cloud infrastructure system 905 and which facilitate the provisioning of services by cloud infrastructure system 905. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 905 may comprise multiple subsystems. These subsystems may be implemented in software, or hardware, or combinations thereof. As depicted in FIG. 9, the subsystems may include a user interface subsystem 930 that enables users or subjects of cloud infrastructure system 905 to interact with cloud infrastructure system 905. User interface subsystem 930 may include various interfaces such as a web interface 935, an online store interface 940 where cloud services provided by cloud infrastructure system 905 are advertised and are purchasable by a consumer, and other interfaces 945. For example, a subject may, using a subject device, request (service request 975) one or more services provided by cloud infrastructure system 905 using one or more of interfaces 935, 940, and 945. For example, a subject may access the online store, browse cloud services offered by cloud infrastructure system 905, and place a subscription order for one or more services offered by cloud infrastructure system 905 that the subject wishes to subscribe to. The service request may include information identifying the subject and one or more services that the subject desires to subscribe to. For example, a subject may place a subscription order for a Chatbot related service offered by cloud infrastructure system 905. As part of the order, the subject may provide information identifying for input (e.g., utterances).

In certain aspects, such as the embodiment depicted in FIG. 9, cloud infrastructure system 905 may comprise an Order Management Subsystem (OMS) 950 that is configured to process the new order. As part of this processing, OMS 950 may be configured to: create an account for the subject, if not done already; receive billing and/or accounting information from the subject that is to be used for billing the subject for providing the requested service to the subject; verify the subject information; upon verification, book the order for the subject; and orchestrate various workflows to prepare the order for provisioning.

Once properly validated, OMS 950 may then invoke Order Provisioning Subsystem (OPS) 955 that is configured to provision resources for the order including processing, memory, and networking resources. The provisioning may include allocating resources for the order and configuring the resources to facilitate the service requested by the subject order. The manner in which resources are provisioned for an order and the type of the provisioned resources may depend upon the type of cloud service that has been ordered by the subject. For example, according to one workflow, OPS 955 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting subject for providing the requested service.

Cloud infrastructure system 905 may send a response or notification 980 to the requesting subject to indicate when the requested service is now ready for use. In some instances, information (e.g., a link) may be sent to the subject that enables the subject to start using and availing the benefits of the requested services.

Cloud infrastructure system 905 may provide services to multiple subjects. For each subject, cloud infrastructure system 905 is responsible for managing information related to one or more subscription orders received from the subject, maintaining subject data related to the orders, and providing the requested services to the subject. Cloud infrastructure system 905 may also collect usage statistics regarding a subject's use of subscribed services. For example, statistics may be collected for the amount of storage used, the amount of data transferred, the number of users, and the amount of system up time and system down time, and the like. This usage information may be used to bill the subject. Billing may be done, for example, on a monthly cycle.

Cloud infrastructure system 905 may provide services to multiple subjects in parallel. Cloud infrastructure system 905 may store information for these subjects, including possibly proprietary information. In certain aspects, cloud infrastructure system 905 comprises (Avoid using Claim language) an identity management subsystem Identity Management Subsystem (IMS) 970 that is configured to manage the subject's information and provide the separation of the managed information such that information related to one subject is not accessible by another subject. IMS 970 may be configured to provide various security-related services such as identity services, such as information access management, authentication and authorization services, services for managing subject identities and roles and related capabilities, and the like.

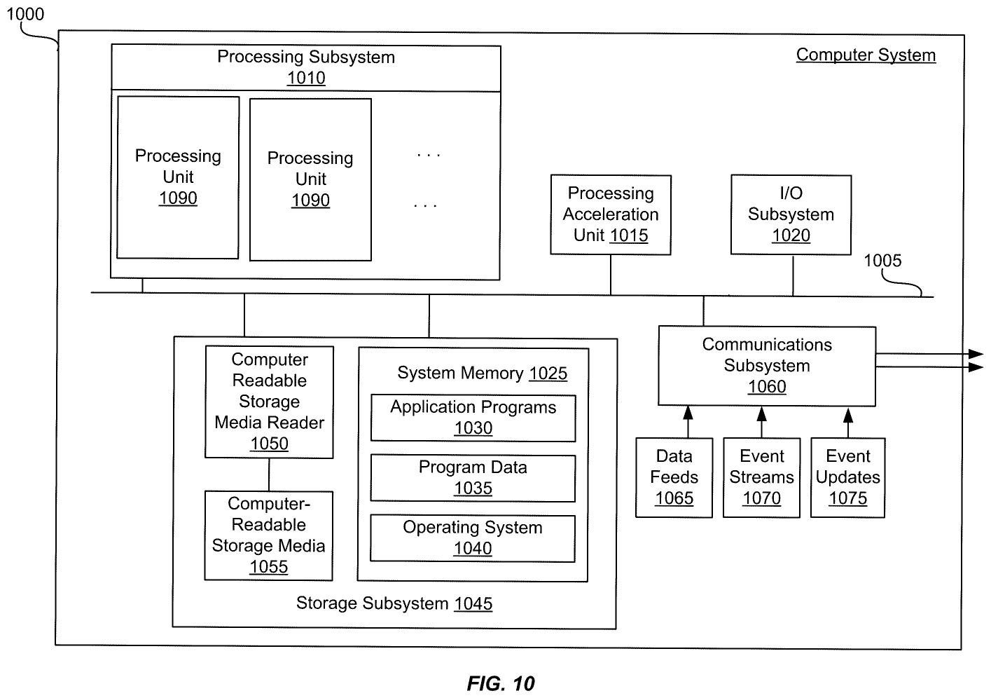

FIG. 10 illustrates an exemplary computer system 1000 that may be used to implement certain aspects of system 100 for creating, managing, and transmuting containerized applications to provide machine architecture neutrality underneath machine-neutral applications. For example, in some respects, computer system 1000 may be used to implement any of the systems for creating, managing, and transmuting containerized applications to provide machine architecture neutrality underneath machine-neutral applications shown in FIG. 1 and various servers and computer systems described above. As shown in FIG. 10, computer system 1000 includes various subsystems including a processing subsystem 1010 that communicates with a few other subsystems via a bus subsystem 1005. These other subsystems may include a processing acceleration unit 1015, and I/O subsystem 1020, a storage subsystem 1045, and a communications subsystem 1070. Storage subsystem 1045 may include non-transitory computer-readable storage media including storage media 1055 and a system memory 1025.

Bus subsystem 1005 provides a mechanism for letting the various components and subsystems of computer system 1000 communicate with each other as intended. Although bus subsystem 1005 is shown schematically as a single bus, alternative aspects of the bus subsystem may utilize multiple buses. Bus subsystem 1005 may be any of several types of bus structures including a memory bus or memory controller, a peripheral bus, a local bus using any of a variety of bus architectures, and the like. For example, such architectures may include an Industry Standard Architecture (ISA) bus, a Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P13127.1 standard, and the like.

Processing subsystem 1010 controls the operation of computer system 1000 and may comprise one or more processors, Application Specific Integrated Circuits (ASICs), or Field Programmable Gate Arrays (FPGAs). The processors may include single-core, or multicore processors. The processing resources of computer system 1000 can be organized into one or more processing units 1090, 1080, etc. A processing unit may include one or more processors, one or more cores from the same or different processors, a combination of cores and processors, or other combinations of cores and processors. In some embodiments, processing subsystem 1010 can include one or more special-purpose co-processors such as graphics processors, digital signal processors (DSPs), or the like. In some embodiments, some or all of the processing units of processing subsystem 1010 can be implemented using customized circuits, such as ASICs, or FPGAs.

In some embodiments, the processing units in processing subsystem 1010 can execute instructions stored in system memory 1025 or on computer-readable storage media 1055. In various aspects, the processing units can execute a variety of programs or code instructions and can maintain multiple concurrently executing programs or processes. At any given time, some, or all of the program code to be executed can be resident in system memory 1025 and/or on computer-readable storage media 1055 including potentially on one or more storage devices. Through suitable programming, processing subsystem 1010 can provide various functionalities described above. In instances where computer system 1000 is executing one or more virtual machines, one or more processing units may be allocated to each virtual machine.

In certain aspects, a processing acceleration unit 1015 may optionally be provided for performing customized processing or for off-loading some of the processing performed by processing subsystem 1010 to accelerate the overall processing performed by computer system 1000.

I/O subsystem 1020 may include devices and mechanisms for inputting information to computer system 1000 and/or for outputting information from or via computer system 1000. In general, use of the term input device is intended to include all possible types of devices and mechanisms for inputting information to computer system 1000. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 370 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1000 to a user or other computer. User interface output devices may include a display subsystem, indicator lights, or non-visual displays such as audio output devices, etc. The display subsystem may be a Cathode Ray Tube (CRT), a flat-panel device, such as that using a Liquid Crystal Display (LCD) or plasma display, a projection device, a touch screen, and the like. For example, user interface output devices may include, without limitation, a variety of display devices that visually convey text, graphics, and audio/video information such as monitors, printers, speakers, headphones, automotive navigation systems, plotters, voice output devices, and modems.

Storage subsystem 1045 provides a repository or data store for storing information and data that is used by computer system 1000. Storage subsystem 1045 provides a tangible non-transitory computer-readable storage medium for storing the basic programming and data constructs that provide the functionality of some aspects. Storage subsystem 1045 may store software (e.g., programs, code modules, instructions) that, when executed by processing subsystem 1010 provides the functionality described above. The software may be executed by one or more processing units of processing subsystem 1010. Storage subsystem 1045 may also provide a repository for storing data used in accordance with the teachings of this disclosure.

Storage subsystem 1045 may include one or more non-transitory memory devices, including volatile and non-volatile memory devices. As shown in FIG. 10, storage subsystem 1045 includes a system memory 1025 and a computer-readable storage media 1055. System memory 1025 may include a number of memories including a volatile main random-access memory (RAM) for storage of instructions and data during program execution and a non-volatile Read Only Memory (ROM) or flash memory in which fixed instructions are stored. In some implementations, a basic input/output system (BIOS), containing the basic routines that help to transfer information between elements within computer system 1000, such as during start-up, may typically be stored in the ROM. The RAM typically contains data and/or program modules that are presently being operated and executed by processing subsystem 1010. In some implementations, system memory 1025 may include multiple different types of memory, such as Static Random Access Memory (SRAM), Dynamic Random Access Memory (DRAM), and the like.

By way of example, and not limitation, as depicted in FIG. 10, system memory 1025 may load application programs 1030 that are being executed, which may include various applications such as Web browsers, mid-tier applications, Relational Database Management Systems (RDBMS), etc., program data 1035, and an operating system 1040. By way of example, operating system 1040 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 1055 may store programming and data constructs that provide the functionality of some aspects. Computer-readable media 1055 may provide storage of computer-readable instructions, data structures, program modules, and other data for computer system 1000. Software (programs, code modules, instructions) that, when executed by processing subsystem 1010 provides the functionality described above, may be stored in storage subsystem 1045. By way of example, computer-readable storage media 1055 may include non-volatile memory such as a hard disk drive, a magnetic disk drive, an optical disk drive such as a CD ROM, Digital Video Disc (DVD), a Blu-Ray® disk, or other optical media. Computer-readable storage media 1055 may include, but is not limited to, Zip® drives, flash memory cards, Universal Serial Bus (USB) flash drives, secure digital (SD) cards, DVD disks, digital video tape, and the like. Computer-readable storage media 1055 may also include, Solid-State Drives (SSD) based on non-volatile memory such as flash-memory based SSDs, enterprise flash drives, solid state ROM, and the like, SSDs based on volatile memory such as solid state RAM, dynamic RAM, static RAM, Dynamic Random Access Memory (DRAM)-based SSDs, magneto resistive RAM (MRAM) SSDs, and hybrid SSDs that use a combination of DRAM and flash memory based SSDs.

In certain aspects, storage subsystem 1045 may also include a computer-readable storage media reader 1050 that can further be connected to computer-readable storage media 1055. Reader 1050 may receive and be configured to read data from a memory device such as a disk, a flash drive, etc.

In certain aspects, Computer System 1000 may support virtualization technologies, including but not limited to the virtualization of processing and memory resources. For example, computer system 1000 may provide support for executing one or more virtual machines. In certain aspects, Computer System 1000 may execute a program such as a hypervisor that facilitates the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1000. Accordingly, multiple operating systems may potentially be run concurrently by Computer System 1000.

Communications subsystem 1070 provides an interface to other computer systems and networks. Communications subsystem 1070 serves as an interface for receiving data from and transmitting data to other systems from computer system 1000. For example, communications subsystem 1070 may enable computer system 1000 to establish a communication channel to one or more subject devices via the Internet for receiving and sending information from and to the subject devices. For example, the communication subsystem may be used to transmit a response to a user regarding the inquiry for a Chabot.

Communication subsystem 1070 may support both wired and/or wireless communication protocols. For example, in certain aspects, communications subsystem 1070 may include Radio Frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 1202.XX family standards, or other mobile communication technologies, or any combination thereof), Global Positioning System (GPS) receiver components, and/or other components. In some aspects communications subsystem 1070 can provide wired network connectivity (e.g., Ethernet) in addition to or instead of a wireless interface.

Communication subsystem 1070 can receive and transmit data in various forms. For example, in some embodiments, in addition to other forms, communications subsystem 1070 may receive input communications in the form of structured and/or unstructured data feeds 1075, event streams 1070, event updates 1075, and the like. For example, communications subsystem 1070 may be configured to receive (or send) data feeds 1075 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1070 may be configured to receive data in the form of continuous data streams, which may include event streams 1070 of real-time events and/or event updates 1075, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1070 may also be configured to communicate data from computer system 1000 to other computer systems or networks. The data may be communicated in various forms such as structured and/or unstructured data feeds 1075, event streams 1070, event updates 1075, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a personal digital assistant (PDA)), a wearable device (e.g., a Google Glass® head mounted display), a personal computer, a workstation, a mainframe, a kiosk, a server rack, or any other data processing system. Due to the ever-changing nature of computers and networks, the description of computer system 1000 depicted in FIG. 10 is intended only as a specific example. Many other configurations having more or fewer components than the system depicted in FIG. 10 are possible. Based on the disclosure and teachings provided herein, a person of ordinary skill in art can appreciate other ways and/or methods to implement the various aspects.

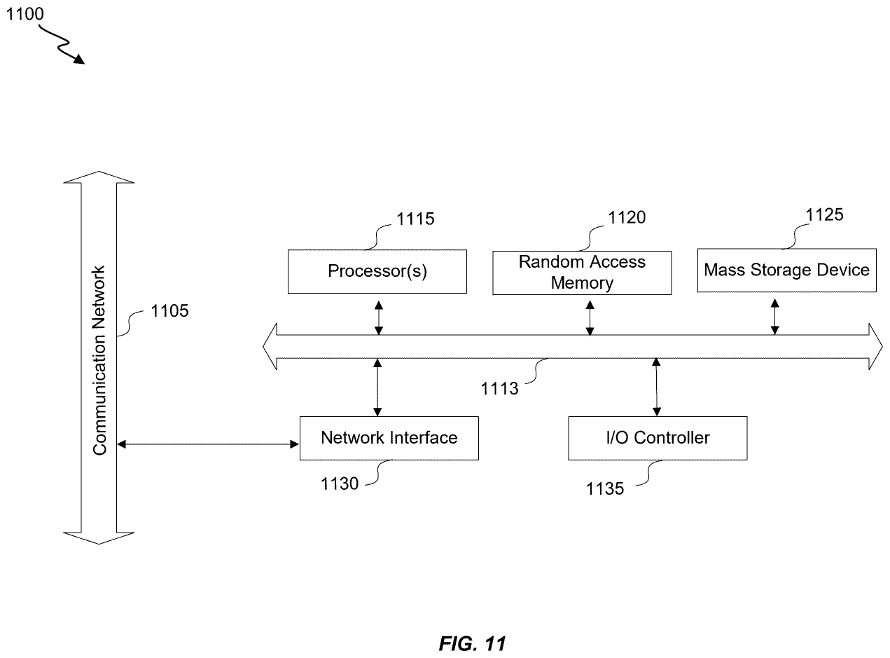

FIG. 11 illustrates an exemplary server which may include a processor, a memory, and a mass storage device. An exemplary Server 1100 may include a processor 1115, a memory (e.g., RAM) 1120, a bus 1110 which couples processor 1115 and memory 1120, a mass storage device 1125 (e.g., a magnetic or optical disk) coupled to processor 1115 and memory 1120 through an I/O controller 1135, and a network interface 1130 coupled to the processor and the memory. Network interface 1130 is further connected to a communication network 1105. Servers may be clustered together to handle more subject traffic and may include separate servers for different functions such as a database server, an application server, and a Web presentation server. Such servers may further include one or more mass storage devices 1125 such as a disk farm or a redundant array of independent disk (“RAID”) system for additional storage and data integrity. Read-only devices, such as compact disk drives and digital versatile disk drives, may also be connected to the servers. Suitable servers and mass storage devices are manufactured by, for example, Compaq, IBM, and Sun Microsystems. Generally, a server may operate as a source of content and provide any associated back-end processing, while an end user can be consumer of content provided by the server. However, it should be appreciated that many of the devices described above may be configured to respond to remote requests, thus operating as a server, and the devices described as servers may operate as end users of remote data sources. In contemporary peer-to-peer networks and environments such as RSS environments, the distinction between end users and servers is a blur. Accordingly, as used herein, the term “server” as used herein is generally intended to refer to any of the above-described servers, or any other device that may be used to provide content such as RSS feeds in a networked environment.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The present description provides preferred exemplary embodiments only, and is not intended to limit the scope, applicability or configuration of the disclosure. Rather, the present description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the present description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-implemented method comprising:
receiving an input container from a client device wherein the input container is a portable and independently executable package of code;
determining, from the input container, an instruction set architecture (ISA) information of an underlying hardware architecture of a deployment environment, wherein the instruction set architecture includes binary representation of a software that runs on a computing machine having one or more particular characteristics;
generating one or more modified input containers based on an identified instruction set architecture by selecting one or more corresponding binary versions of instruction set architecture, one or more compiler configurations associated with the input container, or one or more runtime settings of the input container;
dynamically building one or more machine-dependent layers in the one or more modified input containers;
dynamically inserting the one or more machine-dependent layers are inserted in the one or more modified input containers, wherein the one or more machine-dependent layers are inserted in conjunction with one or more machine-neutral application layers of the input container;
creating dynamic-composition metadata in the one or more modified input containers based on the identified instruction set architecture of a deployment environment, wherein the dynamic-composition metadata includes one or more execution instructions, one or more environment variables, or one or more machine specific attributes;
selecting a matching machine-dependent layer of one or more machine-dependent layers with the instruction set architecture of the deployment environment using the dynamic-composition metadata created in the one or more modified input containers;
inserting the matching machine-dependent layer of one or more machine-dependent layers in the one or more modified input containers;
outputting the one or more modified input containers.

2. The computer-implemented method of claim 1, wherein the one or more machine-dependent layers are built agnostic to instruction set architecture.

3. The computer-implemented method of claim 1, wherein the input container includes a machine-neutral application layer, a metadata layer or one or more machine-dependent layers.

4. The computer-implemented method of claim 1, wherein the instruction set architecture includes an Intel 64-bit instruction set architecture or a 64-bit ARM instruction set architecture.

5. The computer-implemented method of claim 1, wherein determining the instruction set architecture (ISA) information of the underlying hardware architecture of the deployment environment includes evaluating a processor type of an underlying hardware architecture of the deployment environment.

6. The computer-implemented method of claim 1, wherein determining the instruction set architecture (ISA) information of the underlying hardware architecture of the deployment environment includes evaluating one or more available computing resources of an underlying hardware architecture of the deployment environment.

7. The computer-implemented method of claim 1, wherein the determining the instruction set architecture (ISA) information of the underlying hardware architecture of the deployment environment includes evaluating one or more associated instruction sets or one or more hardware configurations of an underlying hardware architecture of the deployment environment.

8. The computer-implemented method of claim 1, further comprising:
building one or more alternate machine-dependent layers in the one or more modified input containers for plurality of instruction set architectures;
dynamically selecting the matching machine-dependent layer with the instruction set architecture of the deployment environment; and
inserting the matching machine-dependent layer in the one or more modified input containers at deployment.

9. The computer-implemented method of claim 1, further comprising:
receiving one or more modified input containers comprising of a machine-neutral application layer, one or more metadata layers, or one or more specified machine-dependent metadata layers of one architecture;
rebuilding a new output container by substituting one or more machine dependent metadata layers in the one or more modified input containers for different one or more machine-dependent metadata layers of another architecture;
outputting the new output container wherein the new output container is configured to dynamically discover and adapt to underlying ISA of the deployment environment.

10. A computer-program product tangibly embodied in a non-transitory machine readable storage medium, including instructions configured to cause one or more data processors to perform a set of actions including:
receiving an input container from a client device wherein the input container is a portable and independently executable package of code;
determining, from the input container, an instruction set architecture (ISA) information of an underlying hardware architecture of a deployment environment, wherein the instruction set architecture includes binary representation of a software that runs on a computing machine having one or more particular characteristics;
generating one or more modified input containers based on an identified instruction set architecture by selecting one or more corresponding binary versions of: instruction set architecture, one or more compiler configurations associated with the input container, or one or more runtime settings of the input container;
dynamically building one or more machine-dependent layers in the one or more modified input containers;
dynamically inserting the one or more machine-dependent layers are inserted in the one or more modified input containers, wherein the one or more machine-dependent layers are inserted in conjunction with one or more machine-neutral application layers of the input container;
creating dynamic-composition metadata in the one or more modified input containers based on identified instruction set architecture of a deployment environment, wherein the dynamic-composition metadata includes one or more execution instructions, one or more environment variables, or one or more machine specific attributes;
selecting a matching machine-dependent layer of one or more machine-dependent layers with the instruction set architecture of the deployment environment using the dynamic-composition metadata created in the one or more modified input containers;
inserting the matching machine-dependent layer of one or more machine-dependent layers in the one or more modified input containers;
outputting the one or more modified input containers.

11. The computer-program product of claim 10, wherein the one or more machine-dependent layers are built agnostic to instruction set architecture.

12. The computer-program product of claim 10, wherein the input container includes a machine-neutral application layer, a metadata layer or one or more machine-dependent layers.

13. The computer-program product of claim 10, wherein the instruction set architecture includes an Intel 64-bit instruction set architecture or a 64-bit ARM instruction set architecture.

14. The computer-program product of claim 10, wherein determining the ISA information of the underlying hardware architecture of the deployment environment includes evaluating a processor type of an underlying hardware architecture of the deployment environment.

15. The computer-program product of claim 10, wherein determining the instruction set architecture (ISA) information of the underlying hardware architecture of the deployment environment includes evaluating one or more available computing resources of an underlying hardware architecture of the deployment environment.

16. The computer-program product of claim 10, wherein the set of actions further comprises:
building one or more alternate machine-dependent layers in the one or more modified input containers for plurality of instruction set architectures;
dynamically selecting the matching machine-dependent layer with the instruction set architecture of the deployment environment; and
inserting the matching machine-dependent layer in the one or more modified input containers at deployment.

17. The computer-program product of claim 10, wherein the set of actions further comprises:
receiving one or more modified input containers comprising of a machine-neutral application layer, one or more metadata layers, or one or more specified machine-dependent metadata layers of one architecture;
rebuilding a new output container by substituting one or more machine dependent metadata layers in the one or more modified input containers for different one or more machine-dependent metadata layers of another architecture;
outputting the new output container wherein the new output container is configured to dynamically discover and adapt to underlying ISA of the deployment environment.

18. A system comprising:
one or more data processors; and
a non-transitory computer readable storage medium containing instructions which, when executed on the one or more data processors, cause the one or more data processors to perform actions including:
receiving an input container from a client device wherein the input container is a portable and independently executable package of code;
determining, from the input container, an instruction set architecture (ISA) information of an underlying hardware architecture of a deployment environment, wherein the instruction set architecture includes binary representation of a software that runs on a computing machine having one or more particular characteristics;
generating one or more modified input containers based on an identified instruction set architecture by selecting one or more corresponding binary versions of: instruction set architecture, one or more compiler configurations associated with the input container, or one or more runtime settings of the input container;
dynamically building one or more machine-dependent layers in the one or more modified input containers;
dynamically inserting the one or more machine-dependent layers are inserted in the one or more modified input containers, wherein the one or more machine-dependent layers are inserted in conjunction with one or more machine-neutral application layers of the input container;
creating dynamic-composition metadata in the one or more modified input containers based on identified instruction set architecture of a deployment environment, wherein the dynamic-composition metadata includes one or more execution instructions, one or more environment variables, or one or more machine specific attributes;
selecting a matching machine-dependent layer of one or more machine-dependent layers with the instruction set architecture of the deployment environment using the dynamic-composition metadata created in the one or more modified input containers;
inserting the matching machine-dependent layer of one or more machine-dependent layers in the one or more modified input containers;
outputting the one or more modified input containers.

19. The system of claim 18, wherein the one or more machine-dependent layers are built agnostic to instruction set architecture.

20. The system of claim 18, wherein the input container includes a machine-neutral application layer, a metadata layer or one or more machine-dependent layers.
